(19) United States
(12) Patent Application Publication
(10) Pub. No.: US 2007/0291400 A1
(43) Pub. Date: Dec. 20, 2007

(54) Storage device with a power-off protective reflex function

(76) Inventor: Ming Cheng Chang, Tucheng City (TW)

Correspondence Address: TROXELL LAW OFFICE PLLC;SUITE 1404, 5205 LEESBURG PIKE, FALLS CHURCH, VA, 22041, US

(21) Appl. No.: 11/657,732

(22) Filed: Jan. 25, 2007

(30) Foreign Application Priority Data
Jan. 27, 2006 (TW) 095202005

(51) Int. Cl. G11B 33/10

(52) U.S. Cl. 360/75

(57) ABSTRACT

The present invention relates to a storage device with a power-off protective reflex function, which comprises: at least a sensor for detecting a motion value with at least one dimension of the storage device; a processor coupled to the sensor for receiving the motion value and initializing a control signal after receiving the motion value; a media unit coupled to the processor for accessing data; and a switch respectively coupled to the processor and the media unit for receiving a control from a control signal to turn on or turn off the power required for accessing the media.

### BACKGROUND OF THE INVENTION

1. Field of the Invention

The present invention relates to a storage device, and more particularly to a storage device with a power-off protective reflex function, which can turn off the power after receiving a motion value of the sensor.

2. Description of the Related Art

A portable hard drive can be connected to a host to access its contents through a connector. However, since the hard drive is a delicate storage device, any unintentionally impact or shock will easily damage the contents it stores, or even cause a permanent damage. Therefore, a general conventional portable hard drive usually has a protective reflex mechanism for protecting the portable hard drive from being impacted and shaken in order to mitigate the damages.

For example, the approved U.S. Pat. No. 5,227,929 (which is applied on Nov. 26, 1990 and approved on Jul. 13, 1993) had disclosed a protective reflex system for a portable computer hard drive, which comprises a 3D accelerometer, a dedicated processor, a general purpose processor, and a hard drive. The 3D accelerometer first initiates a signal to the dedicated processor once it senses that the hard drive suffers the shock of an impact, then the dedicated processor passes a high priority interrupt to the general purpose processor, and finally the general purpose processor breaks or parks the disk heads. However, since this patent requires to use the 3D accelerometer and the general purpose processor, this causes the cost to go up. In addition, the automatic break or park function had been provided by the modem hard drive when power is off by default. Accordingly, the foregoing patent cannot fulfill the requirement for the modem hard drive.

For example, the approved ROC (Taiwanese) Patent No. 275509 (which is applied on Feb. 1, 2005 and published on Sep. 11, 2005) had disclosed a read/write media with a protective reflex system for the external force impact, which senses an external force suffered by the read/write media, calculates and records a state information related to the external force impact. The read/write media at least comprises: a sensor for detecting an external force and passing a detected external force signal to a signal computing unit; the signal computing unit for calculating a value of the external force, when the external force is greater than a threshold predetermined by the mechanism, an impact signal is passed to a central processing unit (CPU) to record an operation state of the read/write media protective reflex system and to record a state information of the external force impact in a recording unit, whereas when the external force is released, a recovery signal is issued to notify the central processing unit (CPU) to recover the operation state of the read/write media protective reflex system for respectively processing various events and further transmitting these events to different units; a recording unit, which is used by the first computing unit to record the state information of the external force impact; a read/write media unit, which is used by the read/write media to store and read/write data; the central processing unit (CPU) for processing the signals of the read/write media protective reflex system and recording and recovering the operation state of the read/write media protective reflex system, when receiving the impact signal, the operation state is recorded and the power is enforced to turn off, when receiving the recovery signal, the operation state of the read/write media protective reflex system is recovered; and a sensor sensitivity adjusting unit for adjusting the sensor's sensitivity, wherein the sensor's sensitivity can be adjusted by the user based on different requirements and multiple levels of sensitivity can be defined. However, a signal processing unit, a recording unit, and a sensor sensitivity adjusting unit are required in this patent, which inevitably increases the cost.

For example, the approved ROC (Taiwanese) Patent No. 281266 (which is applied on Feb. 1, 2005 and published on Nov. 21, 2005) had disclosed a protective reflex system for an external read/write media applied in an information processing apparatus. When it is operating, an external read/write media is inserted into an information processing apparatus through a communication interface to ensure the damages will be reduced when it suffers from an impact of an external force. Wherein, the external read/write media at least comprises: a detecting unit coupled to a signal processing unit for detecting an external force and comparing a value of the external force with a predetermined threshold, if the value is greater than the threshold, an impact signal is initialized, and when the external force is released, a recovery signal is sent out to respectively process various events and further transmit these events to different units; the signal processing unit, which is connected to a central processing unit (CPU) of the information processing apparatus via the communication interface, when receiving the impact signal, a power-off signal is issued, and when receiving the recovery signal, a recovery signal is sent out to respectively process various events and further transmit these events to different units; an external media unit, which is used by the external read/write media to store and read/write data; and a power supply unit for providing a desired power to the read/write media. However, a signal processing unit, a power supply unit, a power controlling unit, and a chargeable/dischargeable element are required in this patent, which inevitably increases the cost. In addition, when power is off, the power supply unit and the power controlling unit continuously provide the power to the read/write media, which causes the read/write media to easily miscarriage and mistaken there is still power, and thus fails to enter into an non-operation mode. In other words, the Auto Park or Load/Unload mechanism of the read/write media cannot achieve its function and fails to protect the read/write media.

### SUMMARY OF THE INVENTION

Therefore, it is a primary objective of the present invention to provide a storage device with a power-off protective reflex function, which comprises a sensor and a switch and can turn off the power of the hard drive after receiving a motion value of the sensor.

To achieve the foregoing objectives, a storage device with a power-off protective reflex function provided by the present invention comprises: at least a sensor for detecting a motion value with at least one dimension of the storage device; a processor coupled to the sensor for receiving the motion value and initializing a control signal after receiving the motion value; a media unit coupled to the processor for accessing data; and a switch respectively coupled to the processor and the media unit for receiving a control from a control signal to turn on or turn off the power required for accessing the media.

### BRIEF DESCRIPTION OF THE DRAWINGS

The accompanying drawings are included to provide a further understanding of the invention, and are incorporated in and constitute a portion of this specification. The drawings illustrate embodiments of the invention, and together with the description, serve to explain the principles of the invention.

FIG. 1 is a schematic block diagram of a storage device with a power-off protective reflex function according to a preferred embodiment of the present invention. FIG. 2 is a schematic diagram showing the device of the present invention which comprises a case, a printed circuit board (PCB), and a connector.

FIG. 3 is a schematic diagram showing the device of the present invention which further comprises an external controlled connector.

### DETAILED DESCRIPTION OF THE PREFERRED EMBODIMENTS

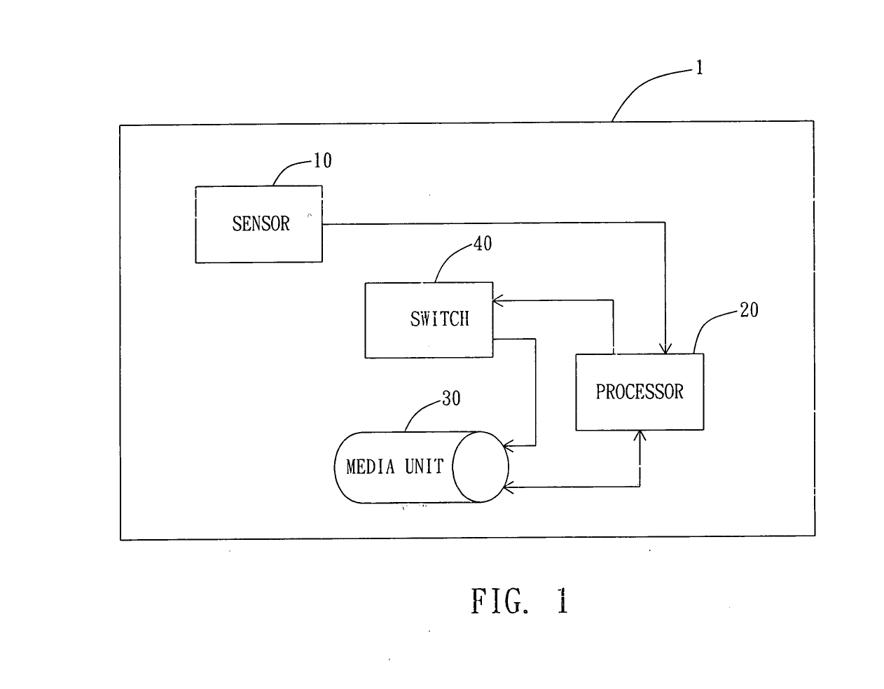

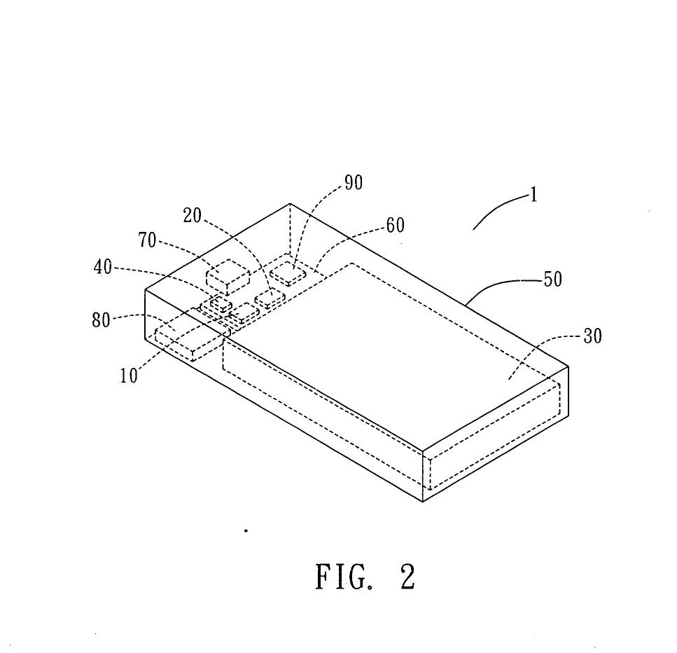

FIG. 1 is a schematic block diagram of a storage device with a power-off protective reflex function according to a preferred embodiment of the present invention. As shown in the drawing, the storage device 1 with the power-off protective reflex function of the present invention comprises: at least a sensor 10, a processor 20, a media unit 30, and a switch 40.

Wherein, the sensor 10 may be an acceleration (G value) sensor or other type of mechanical sensor, which is able to detect a motion value of the storage device. In case the sensor 10 is a 1D, 2D or 3D sensor, the sensor can sense a 1D, 2D or 3D motion value of the media unit 30 when the media unit 30 is declined, fallen, dropped or shaken (for example, 1D is the motion value of X, Y or Z axis; 2D is the motion value of X, Y axis, X, Z axis or Y, Z axis; 3D is the motion value of X, Y, Z axis). The storage device of the present invention uses less number of dimensions (e.g. ID or 2D), thus the cost of the sensor 10 is reduced.

The processor 20 is coupled to the sensor 10, and the processor 20 is for example, but not limited to be a microcontroller. Here, the microcontroller 20 has a memory (not shown) and is able to receive the motion value and pass a control signal to a switch 40 after receiving the motion value. The processor 20 further comprises a control program (not shown), which is stored in the memory for controlling the operation of the microcontroller 20. Wherein, the memory is for example, but not limited to be a flash memory.

The media unit 30 is a hard drive, an internal part of the hard drive, an optical drive, or an internal part of the optical drive, which is coupled to the processor 20 for accessing data. Wherein, the media unit 30 comprises at least a disc and a disk head (not shown), since these components are well known in the prior art and not the main point of the present invention, thus its detailed description is intentionally omitted herein. In addition, the media unit further comprises a mechanism (not shown), with such mechanism, the disk head can be automatically placed on an appropriate position when power is off, so as to prevent the disc or the user data area from being scratched or damaged by the disk head. Wherein, the mechanism is an Auto Park mechanism or a Contact Start-Stop (CSS) mechanism, which configures a landing zone on the inner circle of the disc and automatically places the disk head on the landing zone when power is off. Alternatively, the mechanism may be a Load/Unload mechanism, which configures a landing zone on the outer circle of the disc automatically places the disk head on the landing zone when power is off. The Auto Park mechanism or the Load/Unload mechanism mentioned above is the well-known conventional hard drive technique and not the main point of the present invention, thus its detailed description is intentionally omitted herein. Wherein, the mechanism is for example, but not limited to be the Auto Park mechanism or the Load/Unload mechanism.

The switch 40 is respectively coupled to the processor 20 and the media unit 30 for receiving a control from a control signal to turn on or turn off the power required for accessing the media 30.

As mentioned above, when the device 1 is declined, fallen, dropped or shaken, the sensor 10 can sense an 1D, 2D or 3D motion value of the device 1, and then pass a control signal to the processor 20. Then, the processor 20 controls the switch 40 to turn off the power supplied to the media unit 30. Afterwards, the mechanism embedded in the media unit 30 can place the disk head on a safe position, so as to prevent the disc or user data area from being scratched or damaged by the disk head. In addition, after the switch 40 in the device 1 of the present invention had switched over and the power supplied to the media unit 30 is resumed, an external system will automatically retry the original operation sector, this automatic recovery action is automatically performed without using the present invention, such that the cost is reduced. Additionally, the power-off protective reflex function is performed on the media unit 30 by only using a processor 20 and a sensor 10 in the present invention, thus its cost is reduced. Accordingly, the device 1 of the present invention can effectively resolve the disadvantage of the conventional portable storage device.

FIG. 2 is a schematic diagram showing the device 1 of the present invention which comprises a case, a printed circuit board (PCB), and a connector. As shown in the drawing, the device 1 of the present invention further comprises a case 50, and the case 50 further comprises a printed circuit board (PCB) 60. Wherein, the PCB 60, the sensor 10, the microcontroller 20, the media unit 30, and the switch 40 are all disposed in the case 50. The sensor 10, the microcontroller 20, and the switch 40 are placed on the PCB 60. In addition, the device 1 of the present invention further comprises a connector 70, which is disposed on the PCB 60, coupled to the processor 20 and exposed to the case 50, such that the device 1 can be connected to a host or another device (not shown) through the connector 70 and the host or another device can access the device 1. Wherein, the connector 70 is for example, but not limited to be a USB, OTG, Host USB, IEEE 1394, SAS (Serial Attached SCSI), IDE, CE-ATA or SATA connector. In addition, the device 1 of the present invention may contain a battery 80 and a digital signal processor (DSP)/Processor to process a video or audio signal. For example, the video or audio signal is a signal for a mobile phone, a personal digital assistant (PDA), a game device (Game), a global position system (GPS), a MP3 digital music player, a portable media player (PMP), a digital audio broadcasting device (DAB), or a digital video broadcasting device (DVB).

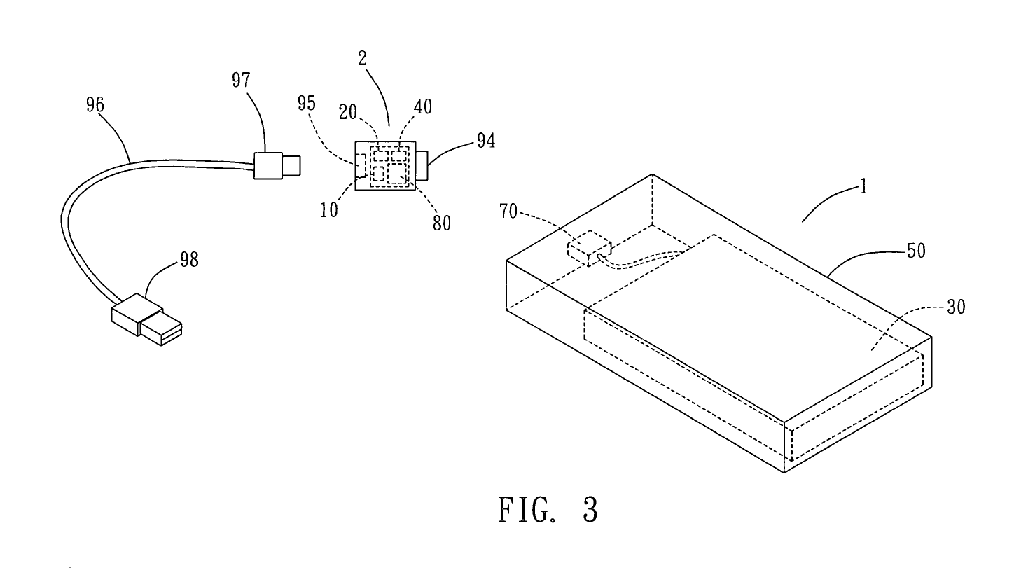

FIG. 3 is a schematic diagram showing the device 1 of the present invention which further comprises an external controlled connector 2. As shown in the drawing, the controlled connector 2 of the present invention comprises: a sensor 10, a processor 20, a switch 40, a first connector 94, and a second connector 95. The controlled connector 2 is connected to a host or another device (not shown) through a cable 96 that respectively has a third connector 97 and a fourth connector 98 on its both ends. Wherein, as for the function of the sensor 10, the processor 20, and the switch 40 please refer to the foregoing description. The first connector 94, the second connector 95, the third connector 97, and the fourth connector 98 are for example, but not limited to be a USB, OTG, Host USB, IEEE 1394, SAS (Serial Attached SCSI), IDE, CE-ATA or SATA connector. Wherein, the first connector 94 is coupled to the connector 70, the third connector 97 is coupled to the second connector 95, and the fourth connector 98 is coupled to the host or another device (not shown). The sensor 10, the processor 20, and the switch 40 are moved to outside of the device 1 of the present invention to achieve the same effect as shown in FIG. 2. Therefore, the controlled connector 2 of the present invention is an external connector with a power-off protective reflex function, and it is connected to the host or external device through the fourth connector 98.

In addition, a chargeable or non-chargeable battery 80 can be additionally added to the controlled connector 2 to provide an additional power for compensating the insufficient power of the device 1, such that the device 1 is converted from a non-portable device into a portable device. Wherein, the deficient power is for example, but not limited to be the insufficient power of the media unit 30.

Additionally, the controlled connector 2 of the present invention may be integrated with the cable 96. In other words, the second connector 95 and the third connector 97 of the controlled connector 2 can be integrated into a single piece and then connected to the host or another device through the cable 96 and the fourth connector 98.

In summary, the storage device with the power-off protective reflex function of the present invention comprises a sensor and a switch. The storage device has an advantage of turning off the power of the hard drive when receiving a motion value of the sensor. The hard drive or the optical drive is superior in providing the Anti-shock, Anti-vibration and Anti-scratch functions in Non-operation mode than in the Operation mode. Accordingly, the present invention can resolve the disadvantages of being easily impacted, shaken and scratched for the conventional portable storage device.

Although the invention has been described with reference to a particular embodiment thereof, it will be apparent to one of the ordinary skills in the art that modifications to the described embodiment may be made without departing from the spirit of the invention. Accordingly, the scope of the invention will be defined by the attached claims not by the above detailed description.

What is claimed is:

1. A device with a power-off protective reflex function, comprising:
at least a sensor for sensing a motion value with at least one dimension of said device;
a processor, being coupled to said sensor for receiving said motion value and initializing a control signal after receiving said motion value;
a media unit, being coupled to said processor for accessing data; and
a switch, being respectively coupled to said processor and said media unit for receiving a control from said control signal to turn on or turn off a power for accessing said media.

2. The device with the power-off protective reflex function as claimed in claim 1, wherein said media unit is a hard drive, an internal part of said hard drive, an optical drive, or an internal part of said optical drive, and comprises at least a disc and a disk head.

3. The device with the power-off protective reflex function as claimed in claim 1, wherein said sensor is an acceleration sensor or other type of mechanical sensor, which can sense a 1D, 2D or 3D motion value of said storage device.

4. The device with the power-off protective reflex function as claimed in claim 1, wherein said processor is a microcontroller, and said microcontroller has a memory.

5. The device with the power-off protective reflex function as claimed in claim 4, further comprising a control program that is stored in said memory for controlling an operation of said microcontroller.

6. The device with the power-off protective reflex function as claimed in claim 4, wherein said memory is for example, but not limited to be a flash memory (FLASH) or a read only memory (ROM).

7. The device with the power-off protective reflex function as claimed in claim 2, wherein said memory unit further comprises a mechanism, with said mechanism, a disk head is placed on an appropriate position when power is off, so as to prevent said disc or a user data area from being scratched.

8. The device with the power-off protective reflex function as claimed in claim 7, wherein said mechanism is an Auto Park mechanism or a Contact Start-Stop (CSS) mechanism, which configures a landing zone on an inner circle of said disc and automatically places said disk head on said landing zone when power is off.

9. The device with the power-off protective reflex function as claimed in claim 7, wherein said mechanism is a Load/Unload mechanism, which configures a landing zone on an outer circle of said disc and automatically places said disk head on said landing zone when power is off.

10. The device with the power-off protective reflex function as claimed in claim 1, further comprising a case that further comprises a printed circuit board (PCB), wherein said sensor, said processor, and said switch are placed on said PCB.

11. The device with the power-off protective reflex function as claimed in claim 10, further comprising a connector that is disposed on said PCB and coupled to said processor and exposed to said case, wherein said device is connected to a host or another device through said connector, such that said host or another device can access said storage device.

12. The device with the power-off protective reflex function as claimed in claim 10, wherein said connector is a USB, OTG, Host USB, IEEE 1394, SAS, CE-ATA or SATA connector.

13. The device with the power-off protective reflex function as claimed in claim 1, wherein said device further comprises a battery and a digital signal processor(DSP)/Processor, said battery provides a desired power to said device, and said digital signal processor(DSP)/Processor processes an video or audio signal.

14. The device with the power-off protective reflex function as claimed in claim 13, wherein said video or audio signal is a signal for a mobile phone, a personal digital assistant (PDA), a game device (Game), a global position system (GPS), a MP3 digital music player, a portable media player (PMP), a digital audio broadcasting device (DAB), or a digital video broadcasting device (DVB).

15. An external controlled connector with a power-off protective reflex function, comprising:
a controlled connector, having a printed circuit board (PCB), wherein the PCB further comprises a sensor, a processor, a switch, a first connector, and a second connector, said sensor senses a motion value with at least one dimension of a device, said processor receives said motion value and initializes a control signal after receiving said motion value, and said switch is coupled to said processor and said first connector for receiving a control from said control signal to turn on or turn off a power of said device.

16. The external controlled connector as claimed in claim 15, wherein said device is a hard drive or an optical drive and has at least a disc and a disk head.

17. The external controlled connector as claimed in claim 15, wherein said sensor Is an acceleration sensor or other type of mechanical sensor, which can sense a 1D, 2D or 3D motion value of said storage device.

18. The external controlled connector as claimed in claim 15, wherein said processor is a microcontroller, said microcontroller has a memory and a control program, and said control program is stored in said memory for controlling an operation of said microcontroller.

19. The external controlled connector as claimed in claim 15, further comprising a battery that is disposed on said PCB for supplying a desired power to said connector.

20. The external controlled connector as claimed in claim 15, further connected to a cable that has a third connector and a fourth connector, wherein said third connector is coupled to said second connector, and said fourth connector is coupled to a host or another device.

21. The external controlled connector as claimed in claim 20, wherein said first connector and said second connector is a USB, OTG, Host USB, IEEE 1394, SAS, IDE, CE-ATA or SATA connector.
